(19) United States
(12) Patent Application Publication
(10) Pub. No.: US 2003/0148158 A1
(43) Pub. Date: Aug. 7, 2003

(54) Fluorosulphonated elastomers with low glass transition based on vinylidene fluoride

(76) Inventors: Bruno Michel Ameduri, Montpellier (FR); Michel Armand, Quebec (CA); Mario Boucher, Quebec (CA); Abdellatif Manseri, Montpellier (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/168,524

(22) PCT Filed: Dec. 29, 2000
(86) PCT No.: PCT/CA00/01585

(30) Foreign Application Priority Data
Dec. 29, 1999 (CA) 2293846
Feb. 24, 2000 (CA) 2299622

(51) Int. Cl. H01M 8/10; H01M 10/40

(52) U.S. Cl. 429/30; 429/316; 429/313; 526/247; 526/255; 526/286; 526/249

(57) ABSTRACT

The present invention describes the synthesis of new sulforated fluorinated elastomers having very low glass transition temperatures (T_{g}), a good resistance to bases, oils and fuels and good properties of workability. These elastomers contain, by way of example, from 80 to 60 mole % of vinylidene fluoride (VDF) and 20 to 40 mole % of perfluoro(4-methyl-3,6-dioxaoct-7-ene) sulfonyl fluoride (PFSO₂F). In this case, they are prepared by radical copolymerisation of VDF and PFSO₂F in the presence of different organic initiators, for example, peroxides, peresters or diazo compounds.

### FIELD OF INVENTION

The present invention concerns the synthesis of new fluoroelastomers having very low glass transition temperatures (T_{g}), a good resistance to acids, to oils and fuels, as well as good workability properties. The elastomers of this invention contain, by way of a non limiting example, from 60 to 80 mole % of vinylidene fluoride (henceforth “VDF”) and 20 to 40 mole % of perfluoro(4-methyl-3,6-dioxaoct-7-ene) sulfonyl fluoride (henceforth “PFSO₂F”). The present invention also pertains to the preparation of these elastomers by radical copolymerisation of the comonomers in the presence of conventional organic initiators, such as peroxides, peresters, diazocompounds or alkyl peroxipivalates.

### PRIOR ART

Fluorinated elastomers exhibit a unique combination of extremely advantageous properties. Among these, we can cite thermal resistance, to oxidation, ultraviolet rays (UV), to degradation due to ageing, to corrosive chemical agents and to fuels. Moreover, they possess low surface tension, dielectric constants and refractive indexes. In addition, they resist the absorption of water. All these properties make for a choice material in diverse high technology applications such as the components of fuel cells, seals in the field of aeronautics, semiconductors in microelectronics, hose connections, piping, pump casings and diaphragms in the chemical, automobile and petroleum industries.

However, elastomers containing vinylidene fluoride (VDF or VF₂) are not numerous. Even though commercial elastomers such as Kel F® (VDF/chlorotrifluoroethylene), Fluorel®, Dai-El®, FKM®, Technoflon®, Viton®A or Viton®B (VDF/HFP or VDF/HFP/TFE) confer good chemical and thermal resistance, their glass transition temperatures (T_{g}) are not sufficiently low. The T_{g} of the aforementionned commercial products generally vary between −10 and −25° C. The lowest value found in the literature is that of Viton®B, with a T_{g} of −26° C., which is surprising because the manufacturer gives a T_{g} varying between −5 and −15° C. for this product. To compete with these elastomers, the company Ausimont proposed a VDF/pentafluoropropene (Technoflon®) copolymer resistant to flames and oxidation, but not having a T_{g} lower than −26° C. and where the comonomer is difficult to obtain.

DuPont has proposed a new generation of elastomers containing perfluoroalkyl vinyl ether (PAVE) resistant to low temperatures. Thus, copolymers have been produced, such as the copolymer of tetrafluoroethylene (TFE)/perfluoromethyl vinyl ether (PMVE) (Kalrez®), whose T_{g} does not fall below −15° C., the TFE/PMVE described in EP 0 077 998, where the T_{g} is −9° C., or the TFE/perfluoroalkylvinylether (PAVE) described in U.S. Pat. No. 4,948,853. But it is mainly the terpolymers which have even lower T_{g} values. Among these, we note the terpolymer TFE/ethylene/PMVE where the T_{g} is −17° C., or the terpolymer TFE/VDF/PAVE (described in EP 0 131 308), and especially the terpolymer TFE/VDF/PMVE (Viton GLT®) where the T_{g} is −33° C.

However, the T_{g} increases with the percentage of TFE in the polymer, which leads to inferior properties of workability. This was also commented on in EP 0 131 308 which describes the synthesis of TFE/PAVE/VDF, even though the elastomers, having been used in O-rings, have very good resistance to polar solvents (see EP 0 618 241, JP-A-3066714 Chem. Abstr., 115:73436 z).

The terpolymerisation of TFE with PMVE and the F₂C═CF[OCF₂CF(CF₃)]ₙOC₃F₇ (Polym. J., 1985, 17, 253) has led to elastomers with a T_{g} (from −9 to −76° C.) that depend on the value of the number of n of HFPO groups and on the percentage of the two oxygenated comonomers.

Finally, DuPont has produced Nafion® membranes by the copolymerisation of TFE with F₂C═CFOCF₂CF(CF₃)OC₂F₄SO₂F (or PFSO₂F). In addition, Asahi Glass uses the same sulfonated monomer in the manufacture of Flemion® membranes. Other monomers with the same functionality, for example F₂C═CFOCF₂CF(CF₃)OC₃F₆SO₂F (for Aciplex® membranes, Asahi Chemical), or CF₂═CFOC₂F₄SO₂F, or carboxylate functionality F₂C═CFO[CF₂CF(CF₃)O]ₓC₂F₄CO₂CH₃ (for the Nafion® or Aciplex® membranes where x equals 1 and for the membranes Flemion® if x equals 0) are also used.

In addition, it is also known that another fluorinated compound, vinylidene fluoride (VDF) produces interesting copolymers from a commercial point of view.

In “Development of Vulcanizable Elastomers Suitable for Use in Contact with Liquid Oxygen” (Third Annual Summary Report; Contract no. NAS8-5352; George C. Marshall Space Flight Center, NASA; Peninsular ChemReasearch Inc.; Jun. 8, 1966; p. 33), P. D. Schuman and E. C. Strump describe the copolymerisation of VDF with perfluoroalkyl vinyl ether of the formula F₂C═CFOR_{F} (R_{F}═CF₃, C₂F₅ and C₃F₇) initiated with azobisisobutyronitrile (AIBN) at very high pressure (approximately 1 000 atm) which leads to fluorinated elastomers having a T_{g} of −20 to −25° C. (for an elastomer containing 43% of F₂C═CFOC₂F₅) and a T_{g} of −31° C. (with 31% of F₂C═CFOC₃F₇ in the copolymer). The process leads to obtaining a copolymer that is difficult to work and dangerous because of the very high pressures required.

Also, U.S. Pat. No. 4,418,186 describes the emulsion copolymerisation of VDF with perfluorovinyl ether F₂C═CFORF where RF represents the group CF₂CF(CF₃)OC₃F₇, which produces elastomers having a T_{g} varying between −29 and −36° C. By introducing a second ether bridge, the suppleness of the copolymer is improved and the value of T_{g} is reduced.

Moreover, EP 0 077 998 describes the solution copolymerisation (in ClCF₂CFCl₂) of VDF with perfluorovinyl ether F₂C═CF(OCF₂CF(CF₃))₂OC₃F₇ initiated by a chlorofluoro perester. The T_{g} of the final product is −41° C. The polymerisation solvent used (CFC) and the costly and dangerous to manipulate initiator constitute two significant limitations.

### DISCLOSURE OF THE INVENTION

The object of the invention is to develop new elastomers having a very low glass transition temperature (T_{g}) and obtained by inexpensive comonomers, such as VDF.

Another object of the invention is the preparation of these elastomers through a simple process not requiring dangerous experimental conditions.

Another object of the invention is to know in a very precise and non ambiguous manner the composition of the copolymers according to the invention, in other words, the molar percentages of each of the comonomers present in the copolymers.

The present invention pertains to elastomers comprising a vinylidene (VDF) comonomer and a perfluorosulfonyl ethoxy propyl vinyl ether fluoride (PSEPVE) or perfluoro(4-methyl-3,6-dioxaoct-7-ene) sulfonyl fluoride (PFSO₂F) these elastomers containing neither tetrafluoroethylene (TFE), nor hexafluoropropene (HFP), nor carrier monomer with a siloxane group and having very low glass transition temperatures (T_{g}) between −32 and −36° C.

In a preferred embodiment, the composition of the elastomer is made up in majority of VDF. A molar percentage of 60 to 80% in the copolymer is particularly preferred. As the second comonomer, a perfluoroalkoxy alkyl vinyl ether such as perfluoro(4-methyl-3,6-dioxaoct-7-ene) sulfonyl fluoride (PFSO₂F) represents a preferred compound. The molar percentage of the second comonomer may vary between 20 and 40% in the copolymer.

The invention also pertains to the process for the preparation of these elastomers, characterised in that the preparation is conducted through radical copolymerisation in the presence of an organic initiator and at a temperature between 20 and 200° C., and for a period of time between 2 and 10 hours, and at an initial pressure between 2 and 100 bars, and allowing the said initial pressure to fall progressively while the monomers are consumed.

The fluorinated elastomers according to this invention can also comprise one or several fluorinated alkenes of which the selection is left to a person skilled in the art.

### DETAILED DESCRIPTION OF THE INVENTION

Considering the state of the art, VDF was selected for the preparation of elastomers for the present invention, the latter being a less expensive alkene and more easily workable than TFE. Being less expensive, it can be used in greater quantity in the copolymer, which can comprise as a second monomer a perfluoroalkoxyalkyl vinyl ether functionality, for example with a carboxylate or a sulfonate. Such perfluoroalkoxy alkyl vinyl ether functionalities are interesting because they favour reticulation sites, in order to produce original elastomers having good resistance at low temperatures and good workability properties. Terpolymers can equally be envisaged where the third copolymer would be preferentially a perfluoroalkyl vinyl ether (PAVE).

The present invention describes the synthesis of original fluorinated elastomer copolymers, containing vinylidene fluoride (VDF) and containing a perfluoroalkyl vinyl ether functionality and/or a perfluoroalkoxyalkyl vinyl ether functionality. Possibly, other fluorinated alkenes can be added. Among the advantages of the present invention, we note:

The synthesis of the fluorinated elastomers is carried out with VDF instead of traditional tetrafluoroethylene (TFE), the latter being largely used in the production of fluorinated elastomers. The direct consequence of this substitution is a reduced cost for the elastomer produced.

The synthesis of the fluorinated elastomers in question in the present invention do not require the use of monomers containing siloxane groups, the latter generally contributing to the reduction of T_{g}, is well known that siloxanes have very low T_{g}. For example, poly(dimethyl siloxane)s have a T_{g} of −120° C. as indicated in a general manner in the following work: The Siloxane Bond: Physical Properties and Chemical Transformations, M. G. Voronkov, V. P. Mileshkevich, and Yu. A. Yuzhelevskii, Consultants Bureau, New York (1978).

The fluorinated elastomers of the present invention have very low T_{g} which vary, for example, generally between −35 and −45° C., these elastomers thus can find applications in the fields of plastics as an agent of workability, or in other advanced technology industries such as aerospace, electronics, the petroleum and automobile industries or the transport of very cold fluids such as liquid nitrogen, liquid oxygen and liquid hydrogen. Moreover, high thermal resistant seals can be produced from these present elastomers. Finally, these elastomers can be used for the manufacture of materials in the field of energy, for example for the preparation of components for fuel cells such as the membranes.

The fluorinated elastomers obtained by the present invention are mainly composed of VDF, and thus not expensive.

The field of the present invention extends to all types of radical polymerisation processes generally used: emulsion, miniemulsion, microemulsion, mass, suspension, microsuspension and solution polymerisation. All can be used according to their conventional workability, but solution polymerisation is preferentially used for reasons of simplicity in the laboratory uniquely, because in the case of solution polymerisation, operating pressures are not high, in the order of 20 to 40 bars. In the case of emulsion, mass and suspension polymerisation, the operating pressure is higher, in the order of 40 to 100 bars.

The various fluorinated alkenes used as the third comonomer have at most four carbon atoms and a structure R₁R₂C═CR₃R₄ where the substituents R₁₋₄ are such that at least one of them is fluorinated or perfluorinated. This thus includes: vinyl fluoride (VF), trifluoroethylene, chlorotrifluoroethylene (CTFE), bromotrifluoroethylene, 1-hydropentafluoropropylene, hexafluoroisobutylene, 3,3,3-trifluoropropene, 1,2-dichlorodifluoroethylene, 2-chloro-1,1-difluoroethylene and in a general way all the fluorinated or perfluorinated vinyl compounds. In addition, perfluorovinyl ethers can also play a role as comonomers. Among them, one can quote perfluoroalkyl vinyl ethers (PAVE) of which the alkyl group have from one to three carbon atoms, for example, perfluoromethyl vinyl ether (PMVE), perfluoroethyl vinyl ether (PEVE) perfluoropropyl vinyl ether (PPVE). These monomers can also be perfluoroalkoxy alkyl vinyl ethers (PAAVE), described in U.S. Pat. No. 3,291,843 and in the periodical Prog. Polym. Sci., 1989, 14, 251, such as perfluoro(2-n-propoxy)propyl vinyl ether, perfluoro(2-methoxy)propyl vinyl ether, perfluoro(3-methoxy)propyl vinyl ether, perfluoro(2-methoxy)ethyl vinyl ether, perfluoro(3,6,9-trioxa-5,8-dimethyl)-dodeca-1-ene, perfluoro(5-methyl-3,6-dioxo)-1-nonene. Moreover, the perfluoroalkoxyalkyl vinyl ether monomers with carboxylic end-groups or sulfonyl fluoride end-groups, such as perfluoro(4-methyl-3,6-dioxaoct-7-ene) sulfonyl fluoride, can also be used for the synthesis of the fluorinated elastomers according to this invention. Mixtures of PAVE and PAAVE can be present in the copolymers.

The preferred solvents to carry out the solution polymerisation are advantageously conventional solvents comprising:

esters of the formula R—COOR′ where R and R′ are independently a C₁₅ alkyl group, or an OR″ ester group where R″ is an alkyl containing between 1 and 5 carbon atoms, R can also be represented by H. Preferably, R═H or CH₃ and R′═CH₃, C₂H₅, i-C₃H₇ or t-C₄H₉.

the fluorinated solvents of the type ClCF₂CFCl₂, perfluoro-n-hexane (n-C₆F₁₄), n-C₄F₁₀, perfluoro-2-butyl-tetrahydrofuran (FC 75™); and

the usual solvents such as 1,2-dichloroethane, isopropanol, tertiary butanol, acetonitrile and butyronitrile.

The preferred solvents are methyl acetate, acetonitrile and perfluoro-n-hexane in quantities varying from 30 to 60% by weight.

The reaction temperature for the copolymerisation is preferably between 20 and 200° C., and more preferably between 55 and 140° C. The interior pressure of the polymerisation autoclave varies preferably between 2 and 100 bars, and preferably between 10 and 100 bars, and most preferably between 20 and 35 bars, according to experimental conditions. Although the above intervals are given as an indication, a person skilled in the art would be able to make the appropriate changes as a function properly sought for the elastomers.

In the process according to the invention, the polymerisation can be initiated by the usual radical polymerisation initiators. Representative examples of such initiators are azo compounds (such as AIBN), dialkyl peroxydicarbonates, acetylcyclohexanesulfonyl peroxide, dibenzoyl peroxide, alkyl peroxides, alkyl hydroperoxides, dicumyl peroxide, alkyl perbenzoates and alkyl peroxypivalates. Nevertheless, preference is given to dialkyl peroxydicarbonates, such as diethyl and di-isopropyl peroxydicarbonates and alkyl peroxypivalates such as t-butyl and t-amyl peroxypivalates and, more particularly still, to alkyl peroxypivalates as well as alkyl peroxides, of which t-butyl peroxide and 2,5-dimethyl-2,5-bis(t-butyl peroxy)hexane are members. Preferably, the initial molar ratio between the initiator and the monomers is between 0.3 and 2%.

For the process of emulsion polymerisation, a wide range of co-solvents can be considered, the solvents are present in a mixture with water in a wide range of proportions, for example from 30 to 70% by weight. By the same token, anionic, cationic or non ionic surfactants can be used in quantities varying typically between 1 and 3% by weight. In the process of emulsion or suspension polymerisation, water is generally used as the reaction medium. However, the fluorinated monomers are fairly insoluble in water, and hence the need to use surfactants. In addition, in the process of emulsion or suspension polymerisation, a co-solvent can be added to increase the solubility of the fluorinated comonomers. In this latter case, acetonitrile, acetone or other alkyl alkyl ketones such as methyl ethyl ketone, by way of non limiting example, can be used.

Alternatively, a micro-emulsion polymerisation, as described in EP 0 250 767 or by dispersion, as taught in U.S. Pat. No. 4,789,717; EP 0 196 904; EP 0 280 312 and EP 0 360 292, can be considered.

Chain transferring agents can be used generally to decrease the molar mass of the copolymers. Among these, we can cite the telogens containing bromine or iodine terminal atoms such as, for example, the compounds of type R_{F}X (where R_{F} is a perfluorinated group R_{F}=CₙF₂₊₁, n=1-10, X designates a bromine or an iodine atom). An exhaustive list of various transfer agents used for telomorisation of fluorinated monomers can be found in the review <<Telomerization reactions of Fluoroalkanes>>, B. Améduri and B. Boutevin in the work <<Topics in Current Chemistry>>(Ed. R. D. Chambers), vol. 192 (1997) p. 165, Springer Verlag 1997.

In the case where the elastomers of the present invention contain iodine and/or bromine atoms in the terminal position, these elastomers can be reticulated, or vulcanised, by using peroxides. These well known peroxide systems, for example those described in EP 0 136 596, can perform this task. The vulcanisation of elastomers can also be produced through conventional ionic methods such as described in U.S. Pat. Nos. 3,876,654; 4,259,463; EP 0 335 705 or in the revue Prog. Polym. Sci., 1989, 14, 251; “Fluoroelastomers A. Van Cleeff, in Modem Fluoropolymers, edited by John Scheirs. John Wiley & Sons, New York, 1997. pp. 597-614.”

A wide range of relative percentages of the various copolymers that can be synthesised from the fluorinated monomers used, leading to the production of fluorinated copolymers and terpolymers were studied.

The analysis of elastomers of the present invention by NMR spectroscopy of ¹⁹F and ¹H, if necessary, allows the unambiguous understanding of the molar percentages of comonomers introduced in the product. For example, in Table 1 below, the relationship between the characteristic signals of copolymers VDF/PFSO₂F in the NMR of ¹⁹F and the structure of products was established.

The molar percentages of VDF in the copolymers was determined using equation 1.

$$Molar \% of VDF = \frac{\begin{matrix}( {I}_{- 83} + {I}_{- 91} + {I}_{- 95} + {I}_{- 102} + \\ {I}_{- 108} + {I}_{- 110} + {I}_{- 113} + {I}_{- 116} )\end{matrix}}{\begin{matrix}( {I}_{- 83} + {I}_{- 91} + {I}_{- 95} + {I}_{- 102} + \\ {I}_{- 108} + {I}_{- 110} + {I}_{- 113} + {I}_{- 116} ) + ( {I}_{- 112} )\end{matrix}} \qquad Equation 1$$

where Lᵢ is the value of the integral signal situated at −1 ppm of the NMR spectrum of ¹⁹F.

TABLE 1
NMR characterisation of ¹⁹F of VDF / PFSO₂F

| | Chemical |
|---|---|
| | Displacement |
| Structure | (ppm) |
| —SO₂F | +45 |
| —OCF₂CF(CF₃)OCF₂CF₂SO₂F | −77 to −80 |
| tBuO—CF₂CH₂— | −83 |
| —CH₂CF₂—CH₂CF₂—CH₂CF₂— | −91 |
| —CH₂CF₂—CH₂CF₂—CF₂CH₂— | −95 |
| tBuO—CH₂CF₂—CH₂CF₂— | −102 |
| —CF₂CF(OR_{F}SO₂F)—CH₂CF₂— | −108 |
| CF₂CF(OR_{F}SO₂F)— | −110 |
| —CH₂CF₂—CF₂CF(OR_{F}SO₂F)— | −112 |
| —OCF₂CF(CF₃)OCF₂CF₂SO₂F | −113 |
| —CH₂CF₂—CH₂CF₂—CF₂CH₂— | −116 |
| —CH₂CF₂—CF₂CH₂—CH₂CF₂— | −122 |
| —CH₂CF₂—CF₂CF(OR_{F}SO₂F)—CH₂CF₂— | −125 |
| —CH₂CF₂—CF₂CF(OR_{F}SO₂F)—CH₂CF₂— | −127 |
| —CH₂CF₂—CF₂CF(OR_{F}SO₂F)—CF₂CH₂— | −144 |
| —OCF₂CF(CF₃)OC₂F₄SO₂F | |

The analysis of Table 1 above highlights the head-to-tail and head-to-head sequences of VDF unit blocks (respectively from −91 and −113, −116 ppm) as well as the VDF/PFSO₂F groups.

The copolymers of the present invention can find uses in the production of components for fuel cells such as the membranes, O-rings, pump casings, diaphragms, having very good resistance to oils, fuels, t-butyl methyl ether, alcohols and motor oils, combined with good elastomeric properties, and in particular a very good resistance at low temperatures considering that the copolymers of the present invention have a T_{g} varying between −30 and −40° C. The copolymers also have the advantage that they can be reticulated in the presence of conventional agents.

The present process thus comprises many interesting advantages, it should be known that:

it is conducted in batch operating mode;

it is conducted in solution using classical and commercially available organic solvents;

it comprises a radical polymerisation in the presence of classical and equally commercially available initiators;

the monomer found mainly in the composition of these fluorinated elastomers is VDF, which is clearly less costly and much less dangerous than TFE.

The following examples are given to illustrate the preferred embodiments of the invention, and should not be considered as limiting the scope of the said invention.

### Example 1

Copolymerisation VDF/PFSO₂F (Initial Molar Percentages 71.1/28.9)

A Carius tube of thick borosilicate glass (length of 130 mm, interior diameter of 10 mm, thickness of 2.5 mm, and a total volume of 8 cm³) contains 0.0313 g (0.135 mmol) of t-butyl peroxypivalate at 75%, 1.1881 g (2.66 mmol) of perfluoro(4-methyl-3,6-dioaxoct-7-ene) sulfonyl fluoride or (PFSO₂F) and 1.9595 g (26.4 mmol) methyl acetate and is connected to a vacuum system and purged three times with helium through primary vacuum cycles (100 mmHg)/helium. Then, after at least five cycles of freezing/thawing to eliminate the dissolved oxygen in the solution, the vinylidene fluoride (VDF) (AP=0.28 bar, 0.420 g, 0.007 mol) is trapped under vacuum in a frozen tube in liquid nitrogen, after the discharge of gases found in the calibrated metallic reservoir under pressure. The respective quantities of gas (precision ±8 mg) introduced in the tube were determined by the drop of relative pressure in the discharge reservoir, which is initially filled by a cylinder containing 300 g of VDF. The calibration curve “mass of VDF (in g) as a function of the drop of pressure (in bar)” is determined beforehand. For example, for 0.750 g of VDF, a differential pressure of 0.50 bar was required. The tube, under vacuum and still immersed in liquid nitrogen, is sealed with a blowtorch and placed in the cavity of an agitated furnace at 75° C. for 6 hours to complete the copolymerisation.

After the copolymerisation, the tube is frozen again in liquid nitrogen and hermitically connected to a vacuum system and opened. The gases that did not react are trapped in a pre-weighed metallic trap and immersed in liquid nitrogen. 0.076 g of gas that did not react is trapped. This allows us to deduce the mass conversion rate of VDF according to the following expression:

$$\frac{{m}_{VDF} - 0 , 076}{{m}_{VDF}} = 82 \%$$

where mVDF represents the initial mass VDF introduced.

Then, the yellow liquid obtained is added drop wise into 35 mL of vigorously mixed cold pentane. After being left for 1 hour at 0-5° C., the mixture is poured into a separatory tunnel and decanted. The clear colourless supernatant is removed while the heavy yellow phase is dried at 70° C. under 1 mmHg for 2 hours. 1.21 g of a very viscous and clear liquid is obtained, which corresponds to a mass conversion rate of 75%. The IRTF analysis (IR Nicolet 510 P) of the copolymer reveals the following characteristic vibrations:

IRTF (KBr, cm⁻¹): 1 100-1 300 (v_{CF}); 1 467 (v_{SO2F}).

The copolymer composition, in other words the molar percentages of the two comonomers of the copolymer, was determined by NMR of ¹⁹F (200 or 250 MHz) at ambient temperature, acetone or deuterated DMF were the reference solvents. The NMR reference of ¹⁹F is CFCl₃. The experimental conditions for the NMR were the following: 30° flip angle, 0.7 s acquisition time, 5 s pulse time, 128 accumulation scans and a pulse width of 5 μs.

In addition, this NMR analysis of ¹⁹F allows us to ensure that the copolymer no longer contains any unreacted PFSO₂F, the absence of a signal at −137.5 ppm which is characteristic of the ethylene fluoride sulfonated monomer is proof.

After the corresponding signals of each comonomer have been integrated, the respective molar percentages of VDF/PFSO₂F in the copolymer are 72.0/28.0. The copolymer resembles a colourless resin and has a T_{g} of −34.8° C. The thermogravimetric analysis (TGA) reveals that the copolymer is very stable thermally. In this respect, the temperature registered for a 5% degradation in air is 295° C.

### EXAMPLE 2

Copolymerisation of VDF/PFSO₂F (Initial Molar Percentages 77.9/22.1)

In a 300 mL Hastelloy (HC 276™) reactor, equipped with a gas inlet valve, a pressure relief valve, a pressure indicator, a rupture disk of HC 276™ and a magnetic agitator revolving at 700 rpm, are introduced 47.0 g (0.105 mol) PFSO₂F; 1.30 g (5.6 mmol) of t-butyl peroxypivalate at 75% and 95.20 g methyl acetate. The reactor is closed and its ability to hold a pressure of 20 bars nitrogen is verified. The following cycle is conducted three times: the reactor is placed under vacuum, followed by the introduction of nitrogen at 10-15 bars. These cycles allow for the degassing of the solution. Afterwards, a vacuum of 20 mmHg is produced in the reactor. The reactor is then placed in a bath of acetone/liquid nitrogen so as to obtain an interior temperature in the reactor of approximately −80° C. 23.8 g of vinylidene fluoride (VDF) (0.372 mol) is introduced into the tarred reactor. The reactor is progressively heated to a temperature of 77° C. where it is maintained for 3 hours. The maximum reaction pressure attained is 15 bars. The observed pressure drop after 3 hours at a reaction temperature is 10 bars. After the reaction, the reactor is placed in an ice bath for 30 minutes, and degassing shows a loss of 2.2 g of gas which was not reacted, which corresponds to a conversion rate of gaseous monomers of approximately 91%. The reaction broth is then treated as before through precipitation in cold pentane, and dried. The mass of copolymer recovered is 60.5 g. The copolymer obtained is a viscous orange oil. The mass conversion rate is 85%. IRTF analysis (IR Nicolet 510 P) of the copolymer reveals the following characteristic vibrations:

IRTF (KBr, cm⁻¹) 1 100-1 300 (v_{CF}); 1 467 (v_{SO2F}).

The characterisation by NMR of ¹⁹F (Table 1) allows us to know the molar percentages of the two comonomers in the copolymer, which are 78.3% VDF and 21.7% PFSO₂F. The present copolymer has a T_{g} of −34.5° C. The thermogravimetric analysis (TGA) reveals that the copolymer is very stable thermally. In this regard, the temperature registered for a 5% degradation in air is 340° C.

Other copolymers were prepared according to the aforementioned process and under similar operating conditions, by varying the quantities of each of the comonomers in the mix. The examples of the supplemental radical copolymerisation results (Examples 3, 4 and 5), as well as Examples 1 and 2 described previously, appear in Table 2 below.

TABLE 2
Operating conditions and radical copolymerisation results of VDF with PFSO₂F

| | Mass of | Mass of | Mass of | | Initial | Initial | VDF | PFSO₂F | Conversion | Mass | | T_{degradation} |
|---|---|---|---|---|---|---|---|---|---|---|---|---|
| | VDF | PFSO₂F | Solvent | C₀ | VDF | PFSO₂F | copolymer | copolymer | of VDF | output | T_{g} | in 5% air |
| Example^{a} | (g) | (g) | (g) | (%) | (% mol.) | (% mol.) | (% mol.) | (% mol.) | (%) | (%) | (° C.) | (° C.) |
| 1 | 0.420 | 1.1881 | 1.960^{b} | 2.06 | 71.1 | 28.9 | 72.0 | 28.0 | 82 | 75 | −34.8 | 295 |
| 2 | 23.8 | 47.0 | 95.20b | 0.86 | 77.9 | 22.1 | 78.3 | 21.7 | 91 | 85 | −34.5 | 340 |
| 3 | 0.960 | 1.9603 | 2.121^{b} | 2.04 | 77.3 | 22.7 | 77.7 | 22.3 | 96 | 63 | −32.3 | 345 |
| 4 | 1.145 | 2.0001 | 2.410^{b} | 1.78 | 80.2 | 19.8 | 80.9 | 19.1 | 95 | 60 | −36.1 | 360 |
| 5 | 1.205 | 2.2105 | 2.052^{c} | 0.40 | 78.6 | 21.4 | 81.0 | 19.0 | 55 | 49 | −32.8 | 385 |

^{a}72° C. temperature, duration of 3 to 10 hours, in the presence of t-butyl peroxypivalate
^{b}Methyl acetate
^{c}Acetonitrile
C₀ = [initiator]₀/ ([VDF]₀ + [PFSO₂F]₀). The value of C₀ varies generally between 0.1 and 2%.

Although the present invention has been described through specific embodiments it is understood that many variations and modifications can be attached to these embodiments, and the present disclosure aims to cover such modifications, uses or adaptations of the present invention following, in general, the principles of the invention and including all variations of the present description which become known or accepted practice in the field of activity where the present invention is found, and may be applied to other essential elements mentioned below, and in agreement with the breadth of the following claims.

1. Sulfonated fluorinated elastomer not comprising tetrafluoroethylene, hexafluoropropene or siloxane carrying monomer, and having glass transition temperatures (T_{g}) between −32 and −36° C. and containing a copolymer of vinylidene fluoride (VDF) and perfluorosulfonyl ethoxy propyl vinyl ether fluoride (PSEPVE) or perfluoro(4-methyl-3,6-dioxaoct-7-ene)sulfonyl fluoride (PFSO₂F).

2. Sulfonated fluorinated elastomer according to claim 1, containing 20 to 40 mole % of PSEPVE or PFSO₂F and 80 to 60 mole % VDF.

3. Sulfonated fluorinated elastomer according to claim 1, wherein the copolymer also comprises at least one fluorinated alkene and/or one vinyl perfluorinated ether.

4. Sulfonated fluorinated elastomer according to claim 3, wherein the fluorinated alkene is selected from the group consisting of vinyl fluoride, trifluoroethylene, chlorotrifluoroethylene, bromotrifluoroethylene, 1-hydropentafluoropropylene, hexafluoroisobutylene, 3,3,3-trifluoropropene, 1,2-dichlorodifluoroethylene and 2-chloro-1,1-difluoroethylene.

5. Sulfonated fluorinated elastomer according to claim 3, wherein the vinyl fluorinated ether is selected from the group consisting of perfluoroalkyl vinyl ether, perfluoroalkoxyalkyl vinyl ether or a mix of these.

6. Polymer electrolytes, ionomers, fuel cell components (such as the membranes and the seals), joints, hoses, pipes, O-rings, pump casings, diaphragms, piston heads finding applications in the aeronautic, petroleum, automobile, mining, nuclear and the plastics industries comprising the elastomers according to anyone of the claims 1 to 5.

7. Process for the preparation of fluorinated elastomers by copolymerisation of vinylidene fluoride (VDF) with perfluorosulfonyl ethoxy propyl vinyl ether fluoride (PSEPVE) or perfluoro(4-methyl-3,6-dioxaoct-7-ene) sulfonyl fluoride (PFSO₂F) wherein the production is conducted by radical copolymerisation in the presence of an organic initiator at a temperature between 20 and 200° C., for a period of 2 to 6 hours, and at an initial pressure between 2 and 100 bars, where the said initial pressure is allowed to drop progressively as the monomers are consumed

8. Process according to claim 7, wherein vinylidene fluoride is used in a ratio of 60 to 80 mole %, with the balance constituted by perfluorosulfonyl ethoxy propyl vinyl ether fluoride or perfluoro(4-methyl-3,6-dioxaoct-7-ene) sulfonyl fluoride, and possibly at least one fluorinated alkene and/or vinyl perfluorinated ether.

9. Process according to claim 8, wherein the vinyl perfluorinated ether has a mole ratio of 3 to 50%.

10. Process according to claim 8, wherein the vinyl perfluorinated ether is a perfluoroalkyl vinyl ether selected from a group consisting of perfluoromethyl vinyl ether, perfluoroethyl vinyl ether and perfluoropropyl vinyl ether.

11. Process according to claim 8, wherein the vinyl perfluorinated ether is perfluoromethyl vinyl ether or perfluoropropyl vinyl ether.

12. Process according to claim 7, wherein the vinyl ether is a perfluoroalkoxyalkyl vinyl ether selected from a group consisting of perfluoro(2-n-propoxy)propyl vinyl ether, perfluoro(2-methoxy)propyl vinyl ether, perfluoro(3-methoxy)propyl vinyl ether, perfluoro(2-methoxy)ethyl vinyl ether, perfluoro(3,6,9-trioxa-5,8-dimethyl)-dodeca-1-ene, perfluoro(5-methyl-3,6-dioxo)-1-nonene, alone and in mixtures.

13. Process according to claim 7, wherein the radical copolymerisation is conducted in solution and in the presence of a solvent.

14. Process according to claim 7, wherein the solvent is selected from the group consisting of:
esters of the formula R—COOR′ where R and R′ represent independently C₁₋₅ alkyl or a OR″ group where R″ represents an alkyl group containing 1 to 5 carbon atoms, R can also represent H,
the fluorinated solvents are thus perfluoro-n-hexane,
the usual solvents selected from the group consisting of methyl acetate, 1,2-dichloroethane, isopropanol, tertiary butanol, acetonitrile and butyronitrile.

15. Process according to claim 14, wherein R═H or CH₃ and R′αCH₃ C₂H₅, i-C₃H₇ or t-C₄H₉.

16. Process according to claim 14, wherein the solvent is a fluorinated solvent selected from the group consisting of ClCF₂CFCl₂, n-C₆F₁₄, n-C₄F₁₀ and perfluoro-2-butyl-tetrahydrofuran.

17. Process according to claim 14, wherein the solvent is selected from methyl acetate and acetonitrile.

18. Process according to claim 7, wherein the temperature is situated between 55 and 80° C.

19. Process according to claim 7, wherein the initial pressure is in the order of 10 to 100 bars.

20. Process according to claim 7, wherein the initial pressure is situated between 20 and 40 bars.

21. Process according to claim 7, wherein the radical copolymerisation is conducted by emulsion, miniemulsion, microemulsion, mass, suspension, microsuspension or solution polymerisation.

22. Process according to claim 8, wherein the copolymerisation is conducted with vinylidene fluoride, with PSEPVE or PFSO₂F, at least one vinyl perfluorinated ether and at least one fluorinated alkene, the fluorinated alkene is a compound of structure R₁R₂C═CR₃R₄ where R₁, R₂, R₃ and R₄ are such that at least one of them is fluorinated or perfluorinated.

23. Process according to claim 22, wherein the fluorinated alkene is selected from the group consisting of vinyl fluoride, trifluoroethylene, chlorotrifluoroethylene, bromotrifluoroethylene, 1-hydropentafluoropropylene, hexafluoroisobutylene, 3,3,3-trifluoropropene, 1,2-dichlorodifluoroethylene and 2-chloro-1,1-difluoroethylene.

24. Process according to claim 7, wherein the copolymerisation is conducted in batch mode.

25. Process according to claim 7, wherein the organic initiator is selected from the group consisting of azo compounds, dialkyl peroxydicarbonates, alkyl peroxides, alkyl hydroperoxides, alkyl perbenzoates and alkyl peroxypivalates.

26. Process according to claim 7, wherein the organic initiator is selected from the group consisting of acetylcyclohexanesulfonyl peroxide, dibenzoyleperoxide, dicumyl peroxide, diethyl peroxydicarbonate, di-isopropyl peroxydicarbonate, t-butyl peroxypivalate, t-amyl peroxypivalate and t-butyl cyclohexyl peroxydicarbonate.

27. Process according to claim 7, wherein the initial molar ratio between the initiator and the monomers is between 0.1 and 2%.

28. Process according to claim 7, wherein the copolymerisation is conducted in emulsion.

29. Process according to claim 28, wherein the copolymerisation is conducted in the presence of a surfactant in a range of quantities typically between 1 and 3% by weight.

30. Process according to claim 29, wherein the surfactant is anionic, cationic or non ionic.

31. Process according to claim 30, wherein the surfactant is selected from ammonium salts and perfluorinated sulfonates.

32. Process according to claim 7, wherein the copolymerisation is conducted in the presence of chain transfer agents.
